(19) United States
(12) Patent Application Publication
(10) Pub. No.: US 2007/0125761 A1
(43) Pub. Date: Jun. 7, 2007

(54) Electric oven

(75) Inventors: Hyeun Sik Nam, Seoul (KR); Young Sok Nam, Seoul (KR); Yong Soo Lee, Sihoong-si (KR); Seong Ho Cho, Seoul (KR)

Correspondence Address: GREENBLUM & BERNSTEIN, P.L.C., 1950 ROLAND CLARKE PLACE, RESTON, VA, 20191, US

(73) Assignee: L.G Electronics Inc., Seoul (KR)

(21) Appl. No.: 11/392,751

(22) Filed: Mar. 30, 2006

(30) Foreign Application Priority Data
Dec. 6, 2005 (KR) 117825/2005

(51) Int. Cl. F27D 11/00; A21B 1/22

(52) U.S. Cl. 219/392

(57) ABSTRACT

Provided is an electric oven. The electric oven includes a cavity defining a cooking chamber, a heater mounted in the cavity and a tray member on which food is loaded, the tray assembly being slidably inserted into the cavity and plated to enhance heat absorption rate.

### BACKGROUND OF THE INVENTION

1. Field of the Invention

The present invention relates to an electric oven, and more particularly, to an electric oven that can distribute heat more equally through food and thus improve a cooking speed.

2. Description of the Related Art

An electric oven is generally used for baking or roasting food using heat generated by a heating member installed in a cavity.

A typical electric oven includes a cavity in which food is loaded, an upper heater placed on an inner-top of the cavity and a lower heater placed on an inner-bottom of the cavity. Placed in the cavity is a tray on which the food to be heated or roasted can be placed.

Formed on the inner surface of the cavity are a plurality of guide portions for guiding and supporting the tray into the cavity. The guide portions are vertically spaced apart from each other. A user determines the insertion location of the tray according to the volume of food. That is, the user places the tray at a predetermined height in the cavity according to the volume and height of the food.

In the prior art electric oven, the upper and lower heaters are fixedly installed on the inner-top and bottom of the cavity. Therefore, when the food having a relatively lager volume and thus an upper portion of the food is placed close to the upper heater, the upper portion of the food that directly receives radiation from the upper heater is quickly roasted while the lower portion of the food is relatively slowly heated. As a result, the upper potion of the food burns while the lower portion is underdone. To prevent this, the user must open the oven door and turn over the food by himself/herself after the predetermined time has lapsed. This is troublesome for the user.

### SUMMARY OF THE INVENTION

Accordingly, the present invention is directed to an electric oven, which substantially obviates one or more problems due to limitations and disadvantages of the related art.

An object of the present invention is to provide an electric oven that can distribute the heat uniformly through the food and improve the cooking speed.

Another object of the present invention is to provide an electric oven that can provide a solution of the inconvenience that the user has to turn over the food during cooking by distribute the heat equally through the food.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an electric oven including: a cavity defining a cooking chamber; a heater mounted in the cavity; and a tray member on which food is loaded, the tray assembly being slidably inserted into the cavity and plated to enhance heat absorption rate.

In another aspect of the present invention, there is provided an electric oven including: a cavity; a heat generating unit mounted on an inner-upper and/or inner-lower-inner portion of the cavity; and a broiler fan assembly whose surface is at least partly anodized, the broiler fan assembly being slidably inserted into the cavity.

In still another aspect of the present invention, there is provided an electric oven including: a cavity; a tray member received in the cavity; and a heat generating unit mounted in the cavity, wherein a surface of at least one of the cavity and the tray is plated to enhance a heat absorption rate.

According to the present invention, the food can be uniformly roasted through the upper and lower portions, thereby increasing the cooking speed.

Moreover, the inconvenient problem that the user has to turn over the food during making a steak or the like can be solved by distributing the heat equally through the food.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of an electric oven according to an embodiment of the present invention;

FIG. 2 is a graph illustrating a temperature distribution in a cavity of the electric oven according to the embodiment of the present invention;

FIG. 3 is a perspective view of a broiler fan assembly that is anodized according to an embodiment of the present invention;

FIG. 4 is a perspective view of a broiler fan of the broiler fan assembly depicted in FIG. 3;

FIG. 5 is a perspective view of a broiler fan cover of the broiler fan assembly depicted in FIG. 4; and

FIG. 6 is a perspective view of the electric oven depicted in FIG. 1, when food is loaded on the broiler fan assembly.

### DETAILED DESCRIPTION OF THE INVENTION

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art.

Wherever possible, the same reference numbers will be used to refer to the same or like parts throughout the drawings.

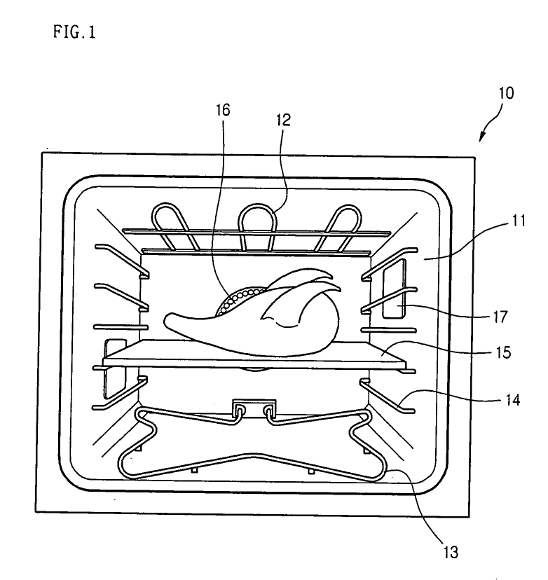

FIG. 1 is a perspective view of an electric oven according to an embodiment of the present invention;

Referring to FIG. 1, an electric oven according to an embodiment of the present invention includes a cavity defining a cooking chamber, an upper heater 12 mounted on an inner-top of the cavity 11, a lower heater 13 mounted on an inner-bottom of the cavity 11, a plurality of rack guides 14 mounted on inner-both sidewalls of the cavity 11, a convection fan 16 mounted on a rear wall of the cavity 11 to circulate air in the cavity 11, a lamp 17 illuminating the interior of the cavity 11 and mounted on a sidewall of the cavity 11, and a conduction plate 15 on which the food can be loaded.

An oven door (not shown) is pivotally mounted on a front portion of the cavity 11 to open and close the front portion of the cavity 11. The rack guides 14 support both side edges of a tray member such as a wire rack or a conduction plate 15. That is, the wire rack or conduction plate 15 on which the food is loaded is inserted into the cavity 11 while sliding along the rack guides 14.

The operation of the above-described electric oven 10 will now be described.

The user first opens the oven door and inserts the tray member on which the food is loaded into the cavity 11 while sliding along the rack guides 14. At this point, the selection of the rack guides along which the tray member is slidably inserted is done according to a volume and height of the food loaded on the tray member. Then, when the user closes the oven door and pushes an operation button, the upper and/or lower heater 12 and/or 13 is heated. Then, A temperature of the air in the cavity 11 increases. Then, the food is roasted by the radiation emitted from the upper and/or lower heater 12 and/or 13 and the convection heat generated by the operation of the convection fan 16. As the lamp 17 illuminates the interior of the cavity 11, the user can observe the cooking state progressed in the cooking chamber.

When the conduction plate 15 is used as the tray member, the heat generated from the upper heater 12 is equally transmitted through the overall portion of the food.

The conduction plate 15 absorbs the heat emitted from the upper heater 12 and discharges the emitted heat to the lower surface of the food, thereby equality roasting the upper and lower surfaces of the food.

That is, a surface of the conduction plate 15 is anodized to absorb a part of the radiation radiated from the heater 12. Here, the conduction plate 15 is formed of high conductive metal and the surface of the conduction plate 15 is anodized to further enhance the heat conductivity. Therefore, a part of the radiation radiated from the heater 12, which does not directly contact the food, is absorbed by the conduction plate 15 and the absorbed radiation is transferred to the lower surface of the food.

The anodizing of the surface of the conduction plate means the anode oxidizing that is one of surface process methods. That is, the anodizing is a kind of plating processes.

Describing the anodizing process in more detail, when an electric current is applied to, for example, an aluminum plate that is to be anodized and serves as the anode, the surface of the aluminum plate is oxidized by oxygen generated at the anode, thereby generating an aluminum oxide (Al₂O₃) layer on the surface of the aluminum plate. The aluminum oxide layer has good corrosion resistance and good thermal absorption. Therefore, when the conduction plate 15 that is anodized is used as the tray member of the electric, gas or microwave oven, the overall surface of the food is equally roasted.

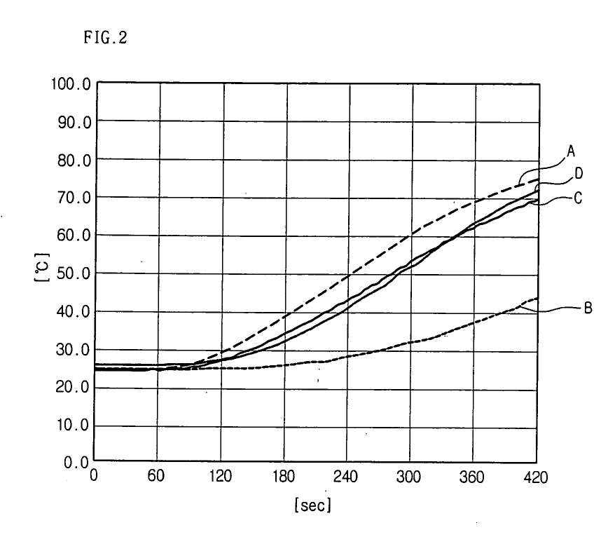

FIG. 2 is a graph illustrating a temperature distribution in the cavity of the electric oven depicted in FIG. 1.

Referring to FIG. 2, when the food is loaded on the anodized conduction plate and roasted, it can be noted from the graph of FIG. 2 that the temperatures of the upper and lower portions of the food equally increase.

In the graph of FIG. 2, an X-axis represents the time and a Y-axis represents the temperature of the food as the time has lapsed. A curve A represents the temperature distribution of the upper portion of the food loaded on a conventional tray and a curve B represents the temperature distribution of the lower portion of the food loaded on the conventional tray.

In addition, a curve C represents the temperature distribution of the upper portion of the food loaded on the anodized conduction tray 15 and a curve D represents the temperature distribution of the lower portion of the food loaded on the anodized conduction tray 15.

As can be noted from the graph, when the food is roasted on the conventional tray, the upper portion of the food, which directly receives the radiation from the heater 12, quickly increases in the temperature as the time has lapsed. On the contrary, since the lower portion of the food cannot sufficiently receive the radiation from the upper heater 12, the temperature of the lower portion of the food does not quickly increase. Therefore, the upper portion of the food may be burn while the lower portion is less roasted.

However, it can be noted from the graph that, when the food is roasted on the anodized conduction plate 15, the upper and lower portions of the food equally increase in the temperature. Therefore, the temperature distribution curves C and C are almost identical to each other. That is, the radiation emitted from the upper heater 12 is absorbed by the conduction plate 15 and the absorbed heat is transferred to the lower portion of the food, thereby distributing the heat equally through the food. Therefore, the food is evenly roasted through its overall surface.

Therefore, there is no need for the user to open the oven door and turn over the food as the heat is distributed equally through the food.

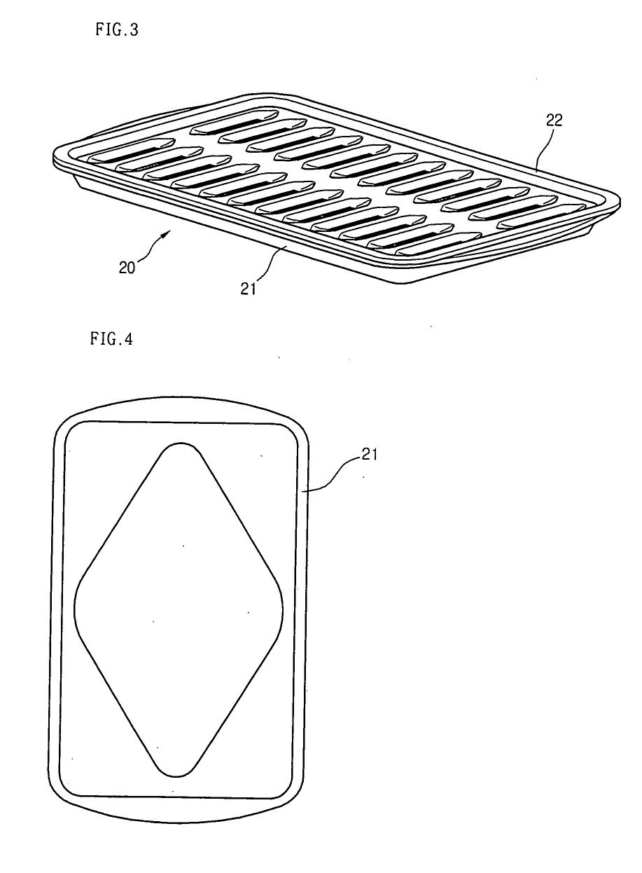

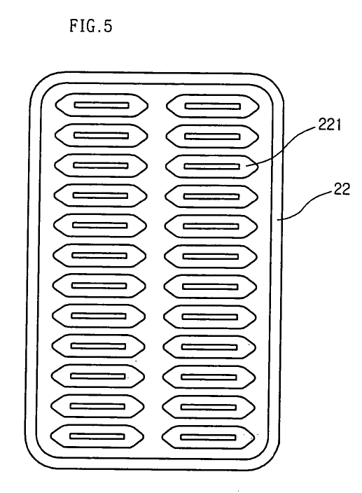

FIG. 3 is a perspective view of a broiler fan assembly that is anodized according to an embodiment of the present invention, FIG. 4 is a perspective view of a broiler fan of the broiler fan assembly depicted in FIG. 3, and FIG. 5 is a perspective view of a broiler fan cover of the broiler fan assembly depicted in FIG. 4.

Referring to FIGS. 3 through 5, the anodizing process for effectively absorbing the radiation emitted from the heater can be applied to a broiler fan assembly.

That is, a broiler fan assembly 20 includes a broiler fan cover 22 provided with a plurality of slots 221 and a top surface on which the food is loaded and a broiler fan 21 on which the broiler fan cover 22 seats.

When fatty food such as ham or meat is roasted on the broiler fan cover 22, juice is extracted from the food. The extracted juice is collected in the broiler fan 21 through the slots 221 formed on the broiler fan 22.

Here, when the broiler fan cover 22 and/or the broiler fan 21 are anodized, the radiation absorbed in the broiler fan cover 22 is distributed equally through the food and the juice flowing out of the food is directed to the broiler fan 21.

The anodizing may be performed for only the top surface of the broiler fan cover 22 or the conduction plate 15 or for the overall surface of the broiler fan cover 22 or the conduction plate 15. That is, when only the upper heater 12 is operated, the radiation is absorbed in only the top surface of the conduction plate 15. Therefore, there is no need to anodize the bottom surface of the conduction plate 15. However, when the upper and lower heaters 12 and 13 are simultaneously operated, it is preferable that the overall surface of the conduction plate 15 or the broiler fan assembly 20 are equally anodized.

In order to enhance the heat absorption rate, in addition to the broiler fan assembly 20, the wire racks or the inner surface of the cavity may be anodized. The wire rack is a gridiron that can be slidably inserted into the cavity along the rack guides 14.

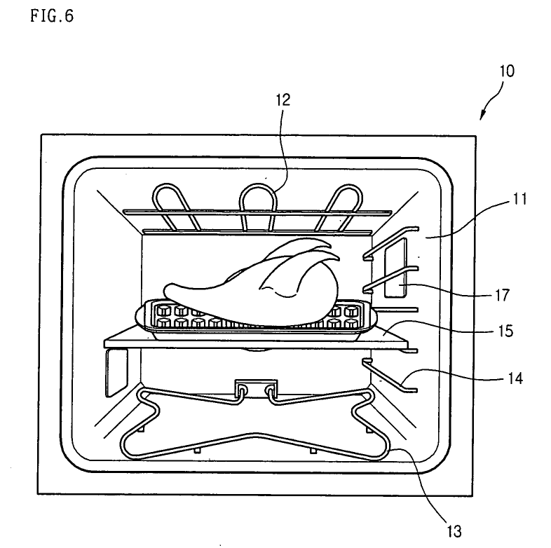

FIG. 6 is an internal perspective view of the electric oven, when the food is loaded on the broiler fan assembly according to an embodiment of the present invention.

Referring to FIG. 6, the conduction plate 15 is inserted into the cavity 11 and the broiler fan assembly 20 is placed on the conduction plate 15. The food to be cooked is loaded on the broiler fan assembly 20. When the user pushes the operation button, the radiation is emitted from the upper and lower heaters 12 and 13. A part of the radiation is absorbed into the upper portion of the food and the rest is absorbed in the broiler fan assembly 20 and/or the conduction plate 15. The radiation absorbed in the broiler fan assembly 20 and/or the conduction plate 15 is transferred to the lower portion of the food. Therefore, the upper and lower portions of the food received in the cavity 11 are equally roasted. Therefore, there is no need to turn over the food.

As shown the drawing, the broiler fan assembly 20 may seat on the conduction plate 15. Alternatively, the broiler fan assembly 20 may be directly supported on the rack guides 14.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An electric oven comprising:
a cavity defining a cooking chamber;
a heater mounted in the cavity; and
a tray member on which food is loaded, the tray assembly being slidably inserted into the cavity and plated to enhance heat absorption rate.

2. The electric oven according to claim 1, wherein the plating of the tray member is performed through an anodizing process.

3. The electric oven according to claim 1, wherein at least one of upper and bottom surfaces of the tray member is anodized.

4. The electric oven according to claim 1, wherein the tray member is selected from the group consisting of a conduction plate, a broiler fan assembly and a wire rack.

5. The electric oven according to claim 1, wherein the tray member is formed of aluminum.

6. The electric oven according to claim 1, wherein the inner surface of the cavity is anodized.

7. An electric oven comprising:
a cavity;
a heat generating unit mounted on an inner-upper and/or inner-lower portion of the cavity; and
a broiler fan assembly whose surface is at least partly anodized, the broiler fan assembly being slidably inserted into the cavity.

8. The electric oven according to claim 7, wherein the broiler fan assembly includes a broiler fan cover provided with a plurality of slots and a broiler fan for collecting materials directed through the slots of the broiler fan cover.

9. The electric oven according to claim 8, wherein at least a part of one of top and bottom surfaces of the broiler fan cover is anodized.

10. The electric oven according to claim 8, wherein at least a part of one of top and bottom surfaces of the broiler fan is anodized.

11. An electric oven comprising:
a cavity;
a tray member received in the cavity; and
a heat generating unit mounted in the cavity,
wherein a surface of at least one of the cavity and the tray is plated to enhance a heat absorption rate.
